(19) United States
(12) Patent Application Publication
(10) Pub. No.: US 2025/0381871 A1
(43) Pub. Date: Dec. 18, 2025

(54) Electric Vehicle Charging Module

(71) Applicant: Capactech Limited, Surrey (GB)

(72) Inventor: Dorian Ian Vargas-Reighley, Surrey (GB)

(21) Appl. No.: 19/243,081

(22) Filed: Jun. 19, 2025

Related U.S. Application Data
(63) Continuation-in-part of application No. 19/138,761, filed on Jan. 1, 0001.

(30) Foreign Application Priority Data
Dec. 14, 2022 (EP) 22213637.6
Mar. 17, 2023 (GB) 2303947.2
May 26, 2023 (GB) 2307946.0
Nov. 8, 2023 (GB) 2317137.4

(51) Int. Cl. B60L 53/60; B60L 53/10; B60L 53/122; B60L 53/22; B60L 55/00; H02J 3/32; H02J 7/00

(52) U.S. Cl. CPC B60L 53/60; B60L 53/11; B60L 53/122; B60L 53/22; B60L 55/00; H02J 3/322; H02J 7/0063; B60L 2210/30

(57) ABSTRACT

A charging module for an electric vehicle (EV), the charging module which includes: a high frequency AC interface, configured to receive and externally output AC at a high frequency of 70 kHz-95 kHz in a high frequency AC mode, a DC interface, configured to receive and externally output DC in a DC mode, a rectification component, a first switch configured to switch the charging module between the high frequency AC mode and the DC mode, and optionally, a second switch configured to switch between the existing EV onboard charger and the charging module, wherein the charging module is configured to be coupled to an existing EV onboard charger, to enable the onboard charger to receive and externally output high frequency AC and DC.

### CROSS REFERENCE TO RELATED APPLICATIONS

This application is a continuation-in-part and claims the benefit of and takes priority from U.S. patent application Ser. No. 19/138,761 filed on Jun. 13, 2025, which in turn is for entry into the U.S. National Phase from which priority is claimed under all applicable sections of Title 35 of the United States Code including, but not limited to, Sections 120, 363, and 365 (c) to International Application No. PCT/EP2023/085967 filed on Dec. 14, 2023, and which in turn claims priority under 35 USC 119 to European Patent Application No. 22213637.6 filed on Dec. 14, 2022, Great Britain Patent Application No. 2303947.2 filed on Mar. 17, 2023, Great Britain Patent Application No. 2307946.0 filed on May 26, 2023 and Great Britain Patent Application 2317137.4 filed on Nov. 8, 2023, the contents of which are incorporated by reference herein in its entirety as part of the present application.

### INTRODUCTION

The present invention relates to charging modules and retrofit kits for electric (motor) vehicles (EVs), and in particular to charging modules and retrofit kits configured to expand the functionality of existing EVs and EV onboard chargers (OBCs) to bidirectionally receive and externally output, high frequency AC and direct current.

### BACKGROUND

EVs have gained significant commercial interest as an environmentally friendly alternative to conventional combustion engine vehicles. A critical component of any electric vehicle is its OBC, which typically rectifies and modulates grid-supplied alternating current (AC) power to direct current (DC) power, suitable for charging the EV's battery.

AC Electric Vehicle Supply Equipment (EVSE) refers to the equipment that delivers alternating current (AC) power from the electricity grid to an EV's battery. This is the most common type of charging method, particularly for home charging and slower public charging. AC EVSE uses the vehicle's OBC to convert AC to DC power before storing it in the vehicle's battery. Typically, AC EVSE supplies standard grid low frequency AC power (typically 50-60 Hz).

Hence, conventional OBCs in existing EVs are typically designed to receive only standard grid low frequency AC power (typically 50-60 Hz), limiting their compatibility with emerging charging technologies such as high-frequency AC wireless charging systems operating in the 70-95 kHz range and various DC fast charging standards. To access these emerging EV charging options, vehicle owners often face significant hardware modifications or complete replacement of the OBC hardware.

Additionally, most existing OBCs are designed for unidirectional power flow, allowing only for the charging of the vehicle's battery from the grid, without the capability to discharge power externally when it might be beneficial.

However, with the evolution of wireless EV charging and smart grid technologies, there is growing interest in high frequency AC/DC charging and bidirectional power flow capabilities, enabling vehicle-to-grid (V2G), vehicle-to-home (V2H), and vehicle-to-load (V2L) functionalities.

These compatibility constraints represent a substantial barrier to the adoption of newer charging technologies and grid integration capabilities for existing EV's.

### SUMMARY OF THE INVENTION

The present invention addresses these limitations by providing a charging module and retrofit kit that can be coupled to an existing EV's OBC, expanding its functionality to bidirectionally receive and deliver both high-frequency AC and DC power. This enables EVs to have bidirectional power flow with respect to a wider variety of power types without the need to replace the existing OBC hardware. Particularly, the invention provides a charging module and retrofit kit that can be coupled to an existing EV's OBC to enable wireless charging functionality.

A charging module in the context of EVs is a component or subsystem designed to manage the power conversion process needed for the charging of a battery of the EV.

The charging module of the present invention enables an existing OBC to be adapted to both receive and externally output electrical power in a high-frequency AC mode operating between 70 kHz and 95 kHz, and a DC mode.

The charging module and retrofit kit of the present invention utilise a first switch for switching between a high-frequency AC interface in the high-frequency AC mode and a DC interface in the DC mode, and a second switch for switching between the charging module as a whole and the pre-existing OBC on the EV. This enables the routing of power between the high-frequency AC interface, the DC interface, and the existing OBC, depending on the user's desired power input/output or available charging infrastructure.

The invention provides a charging module for an electric vehicle (EV), the charging module comprising:
a high frequency AC interface, configured to receive and externally output AC at a high frequency of 70 kHz-95 kHz in a high frequency AC mode,
a DC interface, configured to receive and externally output DC in a DC mode,
a rectification component,
a first switch configured to switch the charging module between the high frequency AC mode and the DC mode, and
optionally, a second switch configured to switch between the
existing EV onboard charger and the charging module, wherein the charging module is configured to be coupled to an existing EV onboard charger, to enable the onboard charger to receive and externally output high frequency AC and DC.

The charging module typically comprises one or more filtration components, wherein at least one of the one or more filtration components are used in both the high frequency AC mode and DC mode and configured to filter high-order harmonics present in high frequency AC input or DC input received from a car pad of the electric vehicle.

Filtration components refer to electrical elements that ‘filter’ input power supplied to the charging module and retrofit kit of the invention by appropriately modulating input power voltage, eliminating (or at least dampening) errant harmonics present in input power and eliminating (or at least reducing) unwanted signal frequencies or interference.

“Pre-rectified” DC refers to input DC that has already undergone rectification prior to entering the charging module (for example via an external rectifier integrated with a wireless power transfer (WPT) charging pad).

One or more filtration components are typically strategically positioned to be utilised in both the high frequency AC mode and DC mode of the charging module and retrofit kit, thus ensuring system protection, efficient component use and vehicle compatibility with various charging infrastructures, including wireless charging systems supplying high frequency AC/“pre-rectified” DC as well as dedicated plug-in DC charging stations.

A key advantage of the present invention is its ability to integrate with an existing EV OBC system, providing a cost-effective route for expanding charging capabilities in conventional EV's that are typically only designed to accept a single power input, typically low-frequency AC.

A further key advantage of the present invention is the strategic positioning of filtration components within the charging module and retrofit kit, such that they are shared between the high frequency AC and DC input streams. This minimises the need for excess components and simplifies manufacturing by combining the high frequency AC and DC inputs into a single stream filtered using one or more shared components.

The invention also provides an EV comprising a charging module of the invention.

The invention further provides a kit for fitting to an EV, which upon fitting configures a pre-existing onboard charger on the EV to additionally receive and externally output:
a) an alternating current at a high frequency of 70 kHz-95 kHz, through a high frequency AC interface in a high frequency AC mode, and
(b) a direct current through a DC interface in a DC mode, wherein the kit comprises a rectification component, a first switch configured to switch the kit between the high frequency AC mode and the DC mode, and a second switch configured to switch between the pre-existing EV onboard charger and the charging module

### DETAILED DESCRIPTION

According to a first aspect of the invention, there is thus provided a charging module for an electric vehicle (EV), the charging module comprising:
a high frequency AC interface, configured to receive and externally output AC at a high frequency of 70 kHz-95 kHz in a high frequency AC mode,
a DC interface, configured to receive and externally output DC in a DC mode,
a rectification component,
a first switch configured to switch the charging module between the high frequency AC mode and the DC mode, and
optionally, a second switch configured to switch between the
existing EV onboard charger and the charging module, wherein the charging module is configured to be coupled to an existing EV onboard charger, to enable the onboard charger to receive and externally output high frequency AC and DC.

Hence, a charging module of the invention, for an electric vehicle (EV), comprises
a rectification component,
a first switch configured to switch the charging module between a frequency AC mode and a DC mode, and
a second switch configured to switch between the existing EV onboard charger and the charging module.
wherein in the high frequency AC mode the charging module can receive and externally output an alternating current at a high frequency of 70 kHz-95 kHz, through high frequency AC interface, and
wherein in the DC mode the charging module can receive and externally output a direct current through a DC interface, and
wherein the charging module is configured to be coupled to an existing EV onboard charger, to enable the onboard charger to additionally receive and externally output high frequency AC and DC.

The charging module of the present invention is designed to couple with an existing OBC of an EV to enable bidirectional power flow capabilities with respect to high frequency AC and DC.

Typically, high frequency AC, is delivered via wireless power transfer (WPT), for example via a car pad inductively coupled with an EV. Hence, preferably the present invention is designed to receive high frequency AC from the secondary coil of an inductive wireless power transfer system. While high-frequency AC may be delivered via alternative means, the charging module of the present invention is most preferably designed to accept high frequency AC efficiently from inductive or wireless sources, such as car pads, at frequencies in the range from 70 or 80 kHz to 90 or 95 kHz (especially 85 kHz). In other words, the charging module is intended for use with an inductive wireless power transfer or native wireless charging system. Therefore, EVs comprising the charging module of the present invention are configured to be wirelessly charged and effectively accept AC at high frequencies.

The charging module can operate in multiple modes, specifically a high-frequency AC mode and a DC mode, with switching mechanisms to transition between these charging modes and to transition between charging using the charging module of the present invention and pre-existing charging system in the EV.

Suitably, the charging module of the present invention comprises a rectifier, or a rectifier component, and it is this rectifier capability that can convert AC to DC (and thus supply the converted DC to the battery, e.g. via the BMS). In EVs of the present invention, there is therefore no need to provide a rectifier separate from the charging module due to the presence of this rectifier/rectifier component.

Thus, an EV of the invention may comprise a means to charge and/or discharge power (or electricity) between the battery (e.g. via the battery management system), and a power supply (such as the grid) or a desired location, such as a dwelling (e.g. a residential dwelling or a workplace).

A charging module of the invention suitably has two interfaces, these being a high frequency AC interface, and a DC interface. These interfaces enable input of power of varying sources to the OBC and, when bidirectional, output of power from the OBC. Also provided is an EV comprising a charging module of the invention with these interfaces.

The EV has one or more bidirectional connections in order to effect such a bidirectional flow of electricity (or power). The EV thus has the ability to discharge DC from the battery (usually via AC) externally, such as to a power supply or dwelling. This involves the battery discharging DC to a charging module of the invention having an inverter and converter functionality, which then inverts and converts the DC to AC at a high frequency of 70-95 kHz (normally about 80-85 kHz and preferably about 85 kHz) and outputs the AC to a car pad; the car pad can then wirelessly transmit power to a receiver not forming part of the electric vehicle, i.e. external to the electric vehicle, such as a ground pad of a wireless electric vehicle charging system. The charging module also has inverter functionality to invert the DC to AC at a high frequency; again, this can be wirelessly transmitted e.g. via the car pad.

The EV is therefore capable of allowing a bidirectional flow of power (or electricity) between an external point and the battery. This is due to the presence of one or more bidirectional connections. For example, there may be a bidirectional connection between an alternating current (AC) frequency converter and the charging module. The EV may comprise an (AC) frequency converter (FC). This FC may be capable of converting AC from one (e.g. higher) frequency to another (e.g. lower) frequency (of AC), such as from a high frequency to a low frequency, for example in the range from 70 or 80 kHz to 90 or 95 kHz (especially 85 kHz) to a lower frequency such as in the range approximately 50-60 Hz (especially 50 Hz and 60 Hz). The FC may also be capable of converting AC from a low (er) frequency to a high (er) frequency, for example from 50-60 Hz (especially 50 Hz and 60 Hz) to 70/80 to 90/95 kHz (especially 85 kHz).

The EV may comprise, an (e.g. AC) frequency converter (FC) capable of converting single phase AC to 3-phase AC, optionally via DC, or vice versa. There is also a bidirectional connection between the charging module and the battery (or BMS), as well as a bidirectional connection between the car pad and the AC frequency converter and a bidirectional connection between the frequency converter and the charging module.

A charging module of the present invention is itself configured to output (a) an AC at a high frequency, and (b) a DC. Hence, direct current discharged from the battery can be output by the charging module in each of these two formats.

A charging module of the present invention may be integrated (electrically connected) with a pre-existing charging system in an EV. Accordingly, the EV may therefore make use of the charging functionality provided by the existing charging system in the EV, while additionally benefiting from the charging functionality provided by the charging module of the present invention.

In the invention, the electric vehicle can be charged wirelessly using magnetic field wireless power transfer (“MF WPT”).

As used herein, the term “central assembly” is used to refer to the power supply in combination with the converter. As used herein, the term “ground assembly” is used to describe the one or more ground pads connected to the converter.

An example of a central and ground assembly combination suitable for supplying power to a plurality of ground pads, such as in the invention, is described in, for example, PCT/EP2022/065760 (published as WO 2022/258782). It will be appreciated that the “wireless charging stations” referred to in that document are equivalent to the “ground pads” of the present invention. AC at a frequency of 70-95 kHz can be supplied from the car pad directly to the OBC of the invention.

A 50 Hz AC output is preferred in countries where 50 Hz has been approved for domestic power supplies. An example of such a country is the UK. However, a 60 Hz output is preferred in countries where 60 Hz has been approved for domestic power supplies. The USA is an example of such a country. It will be appreciated that the frequency required will be determined on a case-by-case basis in accordance with the standards of the country in which the EV is being manufactured and/or used.

Typically, most standard existing EV onboard chargers incorporate functionality to charge via standard AC plug-in chargers which delivers standard grid low frequency AC power at frequencies of 50/60 Hz.

Existing electric vehicles can therefore be charged by plugging them into a socket capable of supplying power, e.g. power from the grid. Typically, this involves connecting the OBC directly to the grid via a cable/plug-in charger, or via a conventional cable/conventional plug-in charger. However, the OBC is bypassed in conventional MF WPT systems. This is because, in such conventional MF WPT systems the rectifier forms part of the vehicle assembly and feeds power directly into the EV's battery. However, an advantage of the present invention is that the charging module does not need to be bypassed, since the charging module can receive a high frequency AC input, unlike conventional OBCs. This means no rectifier component separate to the charging module is needed for high frequency AC input, unlike conventional MF WPT (wireless charging) systems.

Therefore, when the charging module of the invention is integrated (electrically connected) with the pre-existing charging system in an EV, the EV can accept a 50/60 Hz AC input from a standard AC plug-in charger (via the EV's pre-existing charging system) as well as an AC at a high frequency, and a direct current via the charging module.

Low frequency AC input (for example AC at frequencies of 50-60 Hz) from standard AC plug-in chargers supplies power (or electricity) to the EV's battery via the existing charging system in the EV which filters and rectifies the low frequency AC input. The charging module of the invention does not process this 50 Hz or 60 Hz AC input, rather this is done by the EV's pre-existing OBC or charging system. The charging module permits selection between charging via the EV's pre-existing OBC/charging system or via the charging module, depending on the desired or available input/output power type(s).

As described above, the pre-existing charging system in an EV typically accepts a low frequency AC input AC at a frequency, for example from 50-60 Hz. However existing charging systems usually only provide unidirectional flow of power (or electricity); hence bidirectionality with respect to low frequency AC may occur via the AC frequency converter externally connected (bidirectionally) to the charging module in the EV.

In the EV of the invention, an (AC) FC may be provided to change the frequency of the AC outputted from the charging module. In embodiments of the invention, the converter may change (or convert) the frequency of the AC outputted from the charging module by reducing the frequency, such as from a frequency in the kHz range to a frequency in the Hz range. In more preferred embodiments, the converter changes the frequency from high to low, e.g. from 70/80-90/95 kHz to 50-60 Hz. In even more preferred embodiments, the converter changes the frequency from 85 kHz to either 50 Hz or 60 Hz. Suitably, there is a bidirectional connection between the frequency converter and the charging module and/or a bidirectional connection between the charging module and the BMS.

Hence, even if bidirectionality with respect to low frequency AC is not directly provided by the EV's existing charging system, the (AC) frequency converter (FC) externally connected (bidirectionally) to the charging module in the EV of the invention enables bidirectionality with respect to low frequency AC via the conversion of output high frequency AC.

Suitably, the OBC bidirectional connections comply with ISO 15118-20.

When referring to an EV, it is meant a road (or off-road) vehicle which is powered (or motion provided) substantially or mainly by electricity and/or a battery, rather than an internal combustion engine. Preferred vehicles are powered only by electricity. The EV may, however, also be a so-called “hybrid vehicle”, meaning power may be provided by either an internal combustion engine or a battery, or a combination of both. The EV preferably has one or more electric motor(s) which can, or are adapted to, power or drive one or more (road) wheels of the vehicle. However, hybrid vehicles are contemplated which comprise not only an electric motor capable of driving one or more wheel(s) but also, and in addition, an internal combustion (IC) engine. The IC engine may be powered by liquid or fossil fuel such as petrol or diesel, or liquid petroleum gas (LPG) or hydrogen (H₂).

The invention enables electric vehicles to be manufactured at a reduced cost and with fewer component parts (and thus having reduced overall weight) compared to prior art EVs (and particularly prior art EVs that are wireless charging enabled), due to the sharing of components within the charging module across multiple input/output streams. This is achieved whilst retaining the advantages of bidirectionality seen in prior art systems.

The invention also enables electric vehicles to be retrofitted with additional charging capabilities, enhancing its versatility. The present invention's charging module enables a user to retrofit their EV, allowing it to be charged using any type of readily available EV charger (plug-in AC, plug-in DC or via a Wireless Power Transfer (WPT) pad either directly using high frequency AC or via “pre-rectified” DC) and externally discharge power via any one of these power types.

In essence, the present invention's charging module offers the ability to expand the charging capabilities of an EV's pre-existing OBC, especially by enabling the input and output of power wirelessly/inductively in the form of high frequency AC via WPT, by providing all the necessary input and output functionality needed to charge or discharge an EV across multiple types of power.

The present invention's charging module is able to integrate with existing EV OBC system, providing a cost-effective route for expanding charging capabilities.

The ability to accept all types of power can be particularly beneficial when travelling between different jurisdictions. The charging module of the present invention allows EVs to seamlessly accept varying power inputs, making it adaptable to various global standards and allowing the EV to utilise d charging infrastructure without adapters or modifications. This is particularly useful because regions like Europe, North America and the UK use different standards for both AC and DC charging.

Also, the production of EVs of the invention is made simpler by integrating the charging module of the present invention. By integrating the present invention's charging module into EVs, the need for region-specific modifications and additional separate components are reduced, simplifying manufacture and reducing cost.

Furthermore, the standards for bidirectional EV charging vary between jurisdictions and can impact whether an EV can participate in bidirectional charging in a specific country. By having bidirectionality with respect to all power types, the EV of the present invention allows power to be fed back to the grid in all circumstances, as long as the bidirectional infrastructure is available. This is especially important as bidirectional AC charging becomes more widely adopted.

The charging module in the present invention also allows users to select their preferred input or output for their vehicle when multiple options are available (e.g. high-frequency AC over low-frequency AC if wireless charging/discharging is preferred) by enabling switching between the pre-existing EV's charging system and the charging module itself.

With a charging module that natively handles high-frequency AC and DC input/output, EV users also benefit from simplified charging logistics and lower accessory costs, as additional adapters or converters are no longer necessary, ultimately making EV ownership more affordable.

A further aspect of the invention is the strategic positioning of one or more filtration components within the charging module and retrofit kit to ensure system protection through appropriate modulation of input power voltage and reduction of errant harmonics. This ensures that EV's fitted with the charging module are compatible with various charging infrastructures, including wireless vehicle charging pads supplying AC at high frequencies and “pre-rectified” DC as well as conventional plug-in DC charging stations. The one or more filtration components may comprise passive components such as resistors, capacitors, inductors, and combinations thereof as RC (resistor-capacitor), RL (resistor-inductor), LC (inductor-capacitor), LCL (inductor-capacitor-inductor) or RLC (resistor-inductor-capacitor) circuits, or active components such as transistors, or integrated circuits, ora combination of both active and passive filtration components.

An additional aspect of the invention relates to a method of fitting a charging module of the invention to an EV. The method can comprise electrically connecting the charging module to the EV's existing OBC (or charging system), to enable the EV's existing OBC to receive and externally output AC at a high frequency (for example in the range from 70 or 80 kHz to 90 or 95 kHz, especially 85 kHz) and a DC.

A yet further additional aspect of the invention relates to a method of controlling or regulating the charging and/or discharging of an EV (of the invention) or controlling the system (of the invention). The method can comprise allowing or causing power to flow or be outputted from the battery (of the EV) to the power supply (such as the grid) or to a (human) dwelling (e.g. a residential dwelling or aa workplace). The method can comprise a bidirectional flow of electricity/power; for example, the ability of the EV to discharge its battery externally (and so outside the EV). The method may comprise wireless control. It may additionally comprise measuring and/or monitoring various (useful) parameters including, for example, the level of charge in the battery and/or flow rate of power to/from the battery or EV.

The method may comprise controlling one or more (such as multiple) vehicles. In such methods, the controlled system is said to be a “multiplexed” system. The method may comprise identifying one or more vehicles and/or regulating charging and/or discharging of one or more vehicle(s).

The method may involve controlling one or more of the electrical and/or electronic components of the EV, such as the frequency converter, the charging module, the charging module in combination with the existing EV's OBC and/or the BMS of the vehicle.

The EV of the invention can use any suitable AC frequency. However, standards and/or legal restrictions often limit the frequencies that are permitted to be used. Suitably, the frequencies used are 50-60 Hz (processed by the existing EV's OBC) and 70-95 kHz (processed by the charging module). Most preferably, the frequencies are around 50 Hz, around 60 Hz, and around 85 kHz.

Returning to the charging module, the charging module is switchable between one or more modes. Specifically, the charging module is switchable between a high frequency AC mode and a DC mode. The charging module is configured to receive (i) an input AC at a high frequency of 70-95 kHz (preferably about 80-85 kHz, and especially about 85 kHz), and (ii) an input direct current.

By being able to receive a DC input, the charging module may be particularly useful when retrofitting an existing electric vehicle that already has a rectifier component separate to the original OBC because it enables the charging module to receive an input from that rectifier, rather than the rectifier having to supply power directly to the battery (via the BMS). The rectifier may be included as an integral component in a car pad (as described elsewhere herein).

The charging module has a high frequency AC mode, wherein the charging module is configured to receive a high frequency of 70-95 kHz (preferably about 80-85 kHz, and more preferably about 85 kHz) AC input. When in the high frequency AC mode, the charging module may be configured to receive an input from the electric vehicle's car pad. Thus, the high frequency AC mode is typically used for wireless charging.

The charging module additionally has a DC mode, wherein the charging module is configured to receive a DC input. When in DC mode, the charging module may be configured to receive an input from a dedicated plug-in DC charger or a rectifier, which rectifier may in turn be configured to receive an input from the electric vehicle's car pad. Thus, the DC mode may be for plug-in or wireless charging.

Known wireless charging car pads include their own rectifier and receive high frequency AC and output DC; hence, if such a pad is fitted to the vehicle, then its output can provide a DC input to the charging module. In preferred embodiments of the invention, there is no change to how an EV fitted with the charging module receives high power DC. For example, DC power from a DCFC (DC fast charging station) is input directly to the BMS or battery. DC power from a car pad (via a rectifier, as described) is received by the charging module in DC mode. The DC interface of the charging module is thus preferably a low power DC interface or an auxiliary DC interface. In specific embodiments one DC interface tested to date is rated at 11 kW.

The charging module may comprise two switches for switching the charging module between the high frequency AC mode and DC mode. One switch (primary interface switch) is for switching the charging module between the high frequency AC mode, and the DC mode and the other optional switch (secondary interface switch) is for switching between the EV's existing onboard charger and the charging module itself.

The primary interface switch may be positioned directly downstream from the high frequency AC interface and the DC interface, as shown in FIG. 1. Alternatively, as shown in FIG. 2, the primary interface switch may be positioned further downstream after filtration and/or rectification components such that it only receives and/or outputs “pre-rectified” DC or DC via the high frequency AC interface and the DC interface.

By switching the charging module between the above modes and the EV's existing OBC, the electric vehicle may be charged wirelessly or via plug-in charging, as required. It will be appreciated that the charging module should be switched to EV's existing OBC for standard (low frequency) AC charging, the DC mode for charging via a dedicated plug-in DC charger or a “pre-rectified DC” input and to the high frequency AC mode for wireless charging via a WPT car pad. When in the DC mode the OBC may be configured to receive the input DC from a plugin DC charger or a rectifier; the rectifier may receive an input from a car pad of the electric vehicle or may be integral with the car pad.

The charging module may optionally comprise a second switch (secondary interface switch) configured to switch between the existing EV onboard charger and the charging module. This secondary interface switch may be integrated within the charging module or positioned externally (and thus not form part of the charging module) to electrically connect the charging module to the EV's existing onboard charger and the EV's battery.

In either configuration, the secondary interface switch electrically connects the charging module to the EV's existing onboard charger and battery, allowing for the EV's battery to be charged via the EV's existing onboard charger or the charging module. While it is not essential for the secondary interface switch to form part of the charging module itself, it is essential that such a switch is provided to connect the charging module and EV's existing onboard charger to the battery of the EV and allow the EV to switch between the charging functionality provided by the EV's existing onboard and the charging functionality provided by the charging module.

Suitably, the charging module of the present invention comprises a communication interface with the EV's existing onboard charger through which the charging module integrates with the EV's existing onboard charger.

Preferably, the communication interface comprises an internal controller associated with the charging module which facilitates communication between the charging module and a controller associated with the EV's existing onboard charger.

More preferably, the internal controller communicates with the EV's existing OBC controller via a local CAN network or bus associated with the EV's existing onboard charger. Communicating via a pre-existing local CAN network, enables the charging module of the invention to integrate with a wide variety of onboard charging systems as communicating on a local CAN network is the industry standard for communication between separate EV charging systems and within EV systems. The industry standard for communications between EV systems in general is an external CAN network, while the industry standard for communications within EV systems is via internal CAN network(s). Hence, by interfacing with the internal CAN network of the OBC in which it is being integrated, the charging module of the invention communicates within the pre-existing EV system and thus complies with industry standards and can be readily incorporated with various existing OBCs.

Preferably, the charging module of the invention comprises one or more filtration components. Typically, the one or more filtration components comprise a primary filtration component electrically connected between a first switch and a second switch and a secondary filtration component electrically connected between the high frequency AC interface and the first switch.

At least one of the one or more filtration components is preferably configured to filter high-order harmonics and errant frequencies still present following the rectification of high frequency AC. It will be appreciated that both the high frequency AC and “pre-rectified DC” inputs, involve the rectification of high frequency AC and thus possess high-order harmonics the require filtering to produce a DC output suitable for charging an EV's battery. For “pre-rectified” DC input, rectification of high frequency AC takes place externally to the charging module/retrofit kit via a rectifier integral with the car pad. Whereas, for high frequency AC input, rectification takes place via a rectification component forming part of the charging module/retrofit kit.

At least one of the one or more filtration components is preferably shared across both the high frequency AC mode and DC mode. More preferably, at least one of the one or more filtration components is shared across both the high frequency AC mode and DC mode and configured to filter harmonics the high-order and errant frequencies present in high frequency AC input or DC input from a car pad of the electric vehicle. (i.e. “pre-rectified DC” input). This enables the invention to bidirectionally receive and deliver DC power not only through a dedicated plug-in DC charger, but also via a plug-in connection from a car pad supplying “pre-rectified” DC.

Additionally, by using shared filtration components configured to remove high-order harmonics and residual errant frequencies that remain after the rectification of high-frequency AC, the same component(s) can be utilised across multiple input streams. This simplifies the construction of the charging module/retrofit kit by reducing the total number of components and avoiding component duplication which is a problem with existing EV onboard charging systems.

Suitably, the one or more shared filtration components may comprise one or more RC/LCL filtration circuits capable of eliminating (or at least reducing) residual errant frequencies and high-order harmonics present following the rectification of high frequency AC.

It will be appreciated that such filtering is not required for the DC input from a dedicated plug-in DC charger, as this input type does not involve the rectification of high-frequency AC. Accordingly, when the first switch is configured such that the DC interface is active, rather than the high-frequency AC interface, DC power supplied via a dedicated plug-in DC charger passes through the filtration components unchanged.

The charging module may comprise a control network. The control network may be for controlling one or more component(s) of the OBC, such as one or more interface(s) of the charging module. Preferably, the control network is for controlling one or more component(s) of the charging module according to one or more input(s). Preferably, the one or more input(s) relate(s) to one or more of an AC voltage of an inductive (WPT) coil of a car pad, an AC current of an inductive (WPT) coil of a car pad, a voltage across a compensation capacitor of the charging module, a (rectified) DC voltage, a (rectified) DC current, and information about the charging module's pre-charge control, high side relay control, low side relay control, (power module) temperature, and/or gate drive signal.

The control network may comprise one or more sub-network(s), such as a plurality of sub-networks. Preferably, the control network comprises a sub-network for controlling an interface of the charging module associated with the high frequency AC mode and for controlling an interface of the charging module associated with the DC mode.

The control network may comprise a plurality of component(s) configured to communicate, i.e. exchange information, with each other. This may be achieved via one or more communication pathway(s), which may be unidirectional or bidirectional.

The car pad can be connected to a component known as a “compensation network”. The compensation network connected to the car pad of the EV of the invention can be conventional, or as standard in the industry. Such systems usually have a compensation network connected to the car pad.

The invention thus also provides a novel communication network to enable the various components of the system to communicate with each other.

Conventional systems usually have a power supply which supplies power to an inverter/converter. The converter is connected to a controller. This controller broadcasts (often wirelessly) a signal to a controller forming part of the EV (the former controller typically being known in the art as a “ground-side controller”, with the latter controller typically being known in the art as a “vehicle-side controller”). The vehicle-side controller may communicate with the rectifier, an alignment controller, and/or the battery management system (BMS).

The wireless signal used in such a system usually conforms to the same legal standard as domestic Wi-Fi, namely IEEE 802.11n.

The vehicle-side controller may communicate with one or more other components of the electric vehicle. This is achieved, for example, by using a controller area network (CAN).

This CAN may be specific to a particular vehicle or type of vehicle, such as, for example, vehicles produced by different manufacturers. The CAN may conform to the ISO standard ISO 11898.

In the invention, the ground-side controller may be able to recognise/identify a particular vehicle or type of vehicle, for example based on data supplied to it by the vehicle-side controller.

In conventional systems, there is usually a compensation network connected to the ground pad, in addition to the compensation network connected to the car pad. However, in the invention, the system may comprise a (passive) radio frequency identification device (“RFID device”), and this may be connected to the ground pad in addition to the compensation network. This may enable the system to recognise the ground pad at which an electric vehicle has parked, which is not always possible or necessary in prior art systems. Specifically, many conventional wireless electric vehicle charging systems are in the form of one-to-one wireless electric vehicle charging systems. This means there is only one ground pad connected to each converter (typically via a conventional cable). In such one-to-one systems, the ground-side controller may be able to recognise the ground pad at which an electric vehicle has parked by recognising the converter involved (since, if there is only one ground pad connected to that converter, then that ground pad must be the ground pad at which that electric vehicle is parked if that converter is involved).

Once this recognition has been achieved, the ground-side controller may instruct the converter to supply a specified amount of power to that ground pad which can then be wirelessly supplied to the electric vehicle parked there. However, in wireless electric vehicle charging systems such as that disclosed in PCT/EP2022/065760, the wireless electric vehicle charging system may be in the form of a one-to-many wireless electric vehicle charging system. This means there may be a plurality of ground pads connected to each converter, typically via one or more capacitive cables. Capacitive cables for transmitting power between a power source and a load are known in the art and are described in, for example, WO 2010/026380, WO 2019/234449, WO 2021/094783, WO 2021/094782, and WO 2020/120932.

In such one-to-many systems, recognition of the converter involved by the ground-side controller may be insufficient to inform the ground-side controller which ground pad an electric vehicle has parked at (since that electric vehicle could be parked at any one of the ground pads connected to that converter). Thus, it is desirable to provide a means for informing the ground-side controller which ground pad an electric vehicle is parked at in a one-to-many wireless electric vehicle charging system to enable the ground-side controller to instruct the converter to supply the correct ground pad with power when required.

Also provided by the invention is a system comprising one or more ground pads capable of communicating with a ground-side controller and/or a control system. The system of the present invention may comprise one or more ground pads capable of communicating with the ground-side controller and/or the control system, all as defined elsewhere herein. Thus, the system of the present invention may comprise an RFID device connected to each ground pad. The RFID device may inform the ground-side controller (central assembly) as to the presence of an electric vehicle parking at the ground pad (ground assembly), as well as specifically which ground pad has been parked at. The ground-side controller, having received this information from the RFID device, may then instruct the converter to supply power to that particular ground pad which can then be supplied wirelessly to the electric vehicle parked there when required. This RFID device in the ground assembly may also be used as a reference by the vehicle-side controller when communicating to the central assembly (e.g. to the ground-side controller) which ground pad it is mated with.

The RFID technology may thus allow the ground-side controller of the system of the invention to recognise the ground pad at which an electric vehicle has parked

Accordingly, the invention also provides a control system capable of communicating with different types of electric vehicle (EV). This system may comprise a (passive) RFID, optionally connected to one or more ground pads. This system may further comprise a ground-side controller and the RFID may be capable of informing the ground-side controller when an electric vehicle is at the ground pad to which the RFID is connected.

It will be appreciated that, in the invention, the control system and/or the ground-side controller may be capable of controlling the power flow to and from each ground pad. The control system and/or the ground-side controller may, in particular, control the amount of power supplied to each ground pad at a particular time. The control system and/or the ground-side controller may also, in particular, control the amount of power drawn from each ground pad when an electric vehicle is positioned at one or more of the ground pads supplying power to the ground pad. It will be appreciated that the power supplied to, drawn from, each ground pad at a particular time may be different for each ground pad of the system.

In the invention, bidirectionality is important. In addition to obtaining power from a power supply (for example, at a wireless electric vehicle charging point), an EV can itself supply power from its battery to the ground pad (for example, thereby supplying power back to the grid or power supply).

There may be multiple reasons why an EV can supply power by itself. The EV can, in some ways, be thought of as a mobile battery, or mobile electrical power supply. The EV may be charged at a time or location of the user's choice. It may also allow discharge of the battery, again at the time and location of the operator's choice.

For example, some airports may want to allow electric vehicles to park in a long stay car park for a reduced cost, on the condition that the EV operator is willing to allow the airport to extract power from the EV battery when needed. In this way, the airport can use power from EVs; this power may be used to provide power to components or parts of the airport, to charge (other) EVs, or to top up or restore an (original) power level. One can therefore supply power to or from the ground pad when the electric vehicle is parked, i.e. not in use and stationary.

In the present invention, bidirectionality is preferably achieved using the same component (i.e. the converter) rather than two separate components (namely a rectifier for charging and an inverter for resupply to the grid).

Suitably an extra inverter can be installed, for example between the battery and the car pad. This can provide a resupply route (from the battery to the inverter, and then to the car pad) for transmitting power back from the battery to the car pad. This is because the opposite route (from the car pad to the rectifier, and then to the battery) can only run in one direction (since the rectifier is unidirectional). Suitably one can co-locate the inverter component in the car pad.

Preferably, the CSMS can recognise the system, i.e. the central and ground assemblies comprising the converter and all ground pads connected thereto, as a single charging point, rather than recognising each ground pad separately, as there may only be one ground-side converter. This is particularly relevant to systems comprising a ground as assembly such that described in PCT/EP2022/065760 (published as WO 2022/258782).

The CSMS may also preferably communicate with the “vehicular cloud”, for example the network connecting the EV's computer system and/or an app of the owner or operator of the vehicle which may, for example, be installed on their phone. The app may also monitor and/or give information on parameters or useful information relating to the battery, the battery's health, the battery's charge level etc. Suitably the following (pieces of) information can be communicated between the CSMS and the vehicular cloud: the details of the battery charge level and/or the details of which parking bay or location the EV is parked at or located in.

One advantage of this system is that communication from the CSMS to the vehicular cloud may assist to keep information available on the vehicular cloud up to date. This may be possible because of vehicle recognition, suitably via the (included) passive RFID.

An additional advantage of the control system of the invention is the speed with which the information available on the vehicular cloud is updated. In prior art systems the vehicular cloud has to first report information to the CSMS, which may take more time. In the invention the system may be advantageous, for example to operate a fleet of vehicles, where one may want to know (relatively quickly) which vehicles are charged, and which vehicles are not, or the battery charge levels of individual vehicles.

Embodiments of the invention thus provide a multi-interface charging module and retrofit kit for electric vehicles. The charging module and retrofit kit can be coupled to an existing EV's OBC (charging system), expanding its functionality to bidirectionally receive and deliver both high-frequency AC and DC power. The charging module and retrofit kit can be connected with charging components from another manufacturer as well as pre-existing charging components on an EV, through the connection ports (interfaces) illustrated in FIG. 3.

### BRIEF DESCRIPTION OF THE DRAWINGS

The invention is now described with reference to the accompanying drawings in which:

FIG. 1 shows a schematic block diagram of the internal circuitry of a first embodiment of a charging module of the invention, including how it connects with an existing EV charging system;

FIG. 2 shows a schematic block diagram of the internal circuitry of a second embodiment of a charging module of the invention, including the components typically provided in an existing EV's charging system;

FIG. 3 shows a perspective view of a charging module of the invention;

FIG. 4 shows a top-down view of the charging module of FIG. 3, with dimensions;

FIG. 5 shows a side view of the charging module of FIGS. 3 and 4;

FIG. 6 shows a circuit diagram for a charging module of the invention;

FIG. 7 shows a schematic block diagram of the internal circuitry of a charging module of the invention when retrofitted to an EV's existing charging system;

FIG. 8 shows a top-down view of the charging module of FIGS. 3, 4 and 5, with the positioning of key internal components illustrated schematically.

### EXAMPLE 1—HF AC/DC CHARGING MODULE

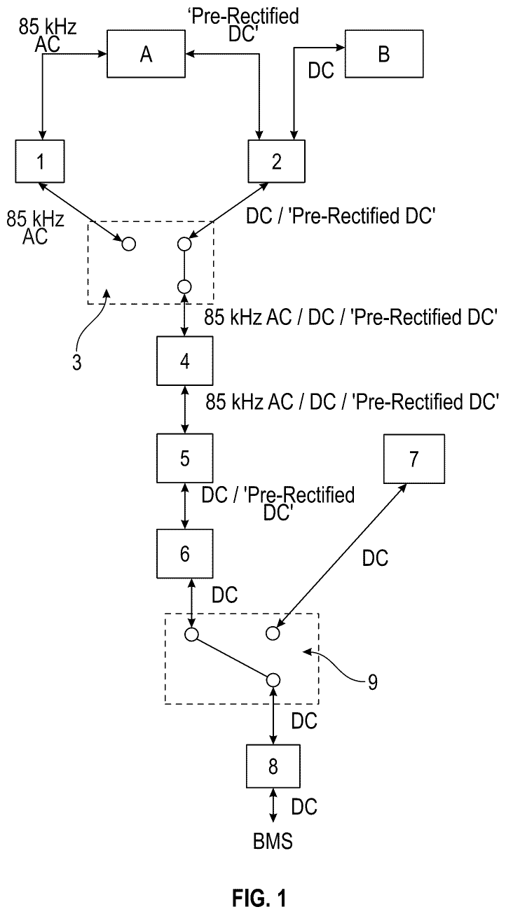

Referring to FIG. 1, a charging module of the invention has two interfaces, these being a high frequency alternating current (AC) interface 1 and a direct current (DC) interface 2.

The charging module of the present invention is designed to couple with an existing charging system of an electric vehicle 7 to expand the charging capabilities of an existing electric vehicle and enable bidirectional power flow to from the vehicle's battery in high frequency AC and DC power modes.

For the purposes of this Example, references to an electrically “upstream” portion of the charging module's circuitry are intended to mean electrical components of the charging module connected close to the input, i.e. the plug-in charger and/or the car pad, whilst references to an electrically “downstream” portion of the charging module circuitry are intended to mean electrical components of the charging module connected close to the output, i.e. the battery management system (BMS). Thus, if one component is said to be electrically “upstream” of another component, then that one component is connected closer to the input than the other. Conversely, if one component is said to be electrically “downstream” of another component, then that one component is connected closer to the output than the other component.

The high frequency AC Interface 1 is configured to receive an AC input from a wireless car pad charger (A) at a frequency of about 85 kHz during wireless charging. This interface 1 then passes this high frequency AC input to a primary interface switch 3 which is configured to switch the charging module between the high frequency AC Interface 1 and DC Interface 2.

The high frequency AC interface 1 suitably conforms to an appropriate industry standard, such as IEC 61851, SAE J1772, GB, GB/T (20234/18487/27930), ISO 15118, SAE J2954, IEC 61980, or a similar standard.

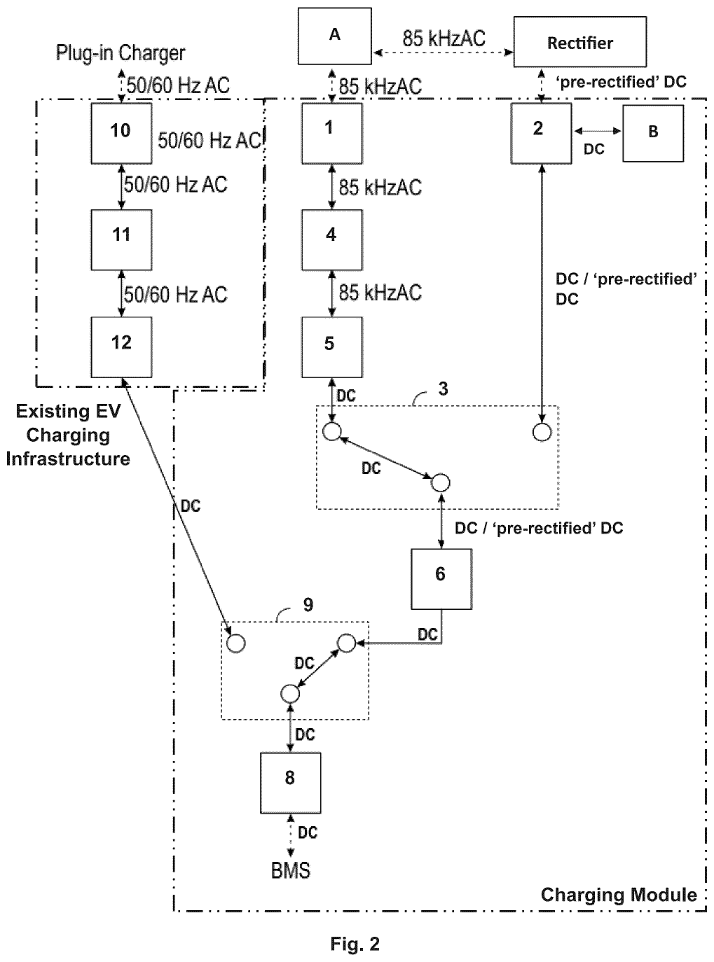

The DC interface 2 is configured to receive a DC input, such as a DC input from a dedicated plugin DC charger (B) or, more commonly, a DC input from a rectifier connected to the vehicle's wireless car pad charger (A). Industry-known car pads include an integral rectifier; their output can thus go into this DC interface. The integrated rectifier in conventional vehicle charging pads is designed to convert an 85 kHz AC input into DC (as shown in FIG. 2), which is then supplied to the DC interface 2. This form of DC is commonly referred to as “pre-rectified DC”, as it has already undergone rectification prior to entering the charging module.

DC Interface 2 thus enables interoperability with those integral rectification in car pads made by manufacturers in the industry.

The DC interface 2 suitably conforms to an appropriate industry standard, such as ISO 15118, DIN 70121, CHAdeMO, CCS, or a similar standard.

The primary interface switch 3 is configured such that only one of the high frequency AC interface 1 and the DC interface 2 may be electrically connected to the downstream components of the charging module at any given time. The primary interface switch 3 may thus be used to switch the OBC between a high frequency AC mode and a DC mode.

In this example, the primary interface switch 3 is positioned directly downstream from the frequency AC interface 1 and the DC interface 2. Alternatively, in the example shown in FIG. 2, the primary interface switch 3 may be positioned further downstream following one or more rectification and filtration components.

When electrically connected, the high frequency AC Interface 1 and/or DC interface 2 pass their high frequency AC input or DC input through a primary filtration unit 4, which eliminates (or at least dampens) errant harmonics in the input high frequency AC before passing the input AC or input DC onto a PFC unit 5. The PFC unit 5 has a rectifier functionality, and thus rectifies the input high frequency AC to DC.

It will be appreciated that for the DC interface 2, the DC supplied passes through the filtration unit 4 and the PFC unit 5 unchanged, irrespective of whether the DC input came from a plugin DC charger (B) or from a rectifier connected to the vehicle's wireless car pad charger (A) as “pre-rectified” DC.

The PFC unit 5 is further connected to a secondary filtration unit 6, as explained in more detail below. “Pre-rectified” DC refers to a DC input that from a rectifier connected externally to the charging module of the invention which is connected to the vehicle's car pad and adapted to convert an 85 kHz AC input to DC to be supplied to the charging module's DC interface 2.

The secondary filtration unit 6 helps to filter high-order harmonics and errant frequencies still present following rectification of the high frequency AC input by the PFC unit 5, as well as those present in “pre-rectified” DC input. For example, DC that has been externally rectified, such as by a rectifier integrated into conventional vehicle charging pads, prior to entering the charging module.

It will be appreciated that this is not an issue for DC input from a dedicated plugin DC charger (B), as this input type has not undergone “pre-rectification” and thus DC input from a plugin DC charger passes through filtration unit 6 unchanged as well as filtration unit 4 and the PFC unit 5.

However, when the DC interface 2 is active and the DC input originates either from a “pre-rectified” source (such as a rectifier associated with a vehicle's wireless car pad charger A) or the input is high frequency AC from the high-frequency AC interface 1, filtration by the secondary filtration unit 6 becomes necessary.

The secondary interface switch 9 is configured to enable power routing and switching between the EV's existing charging system 7 and the charging module of the present invention.

It should be appreciated that the positioning of the primary interface (first) switch 3 and secondary interface (second) switch 9 in the charging module of the present invention enables power to be selectively inputted or outputted from the EV's battery via either the high frequency AC interface 1, DC interface 2 or the existing EV onboard charger.

A notable feature of the invention is that the high-frequency AC mode and the DC mode share at least one downstream component in the charging module, specifically the secondary filtration unit 6. For this reason, the secondary filtration unit 6 is always connected upstream from the secondary interface switch 9. This design choice optimises component utilisation, prevents component duplication and reduces the overall size and cost of the charging module.

The charging module is designed to be used as a retrofit kit which can be coupled to an existing electric vehicle, connecting directly to the original vehicle's charging system. The secondary interface switch 9 facilitates this integration, allowing power to be routed either through the existing vehicle's charging system or through the present invention's charging module depending on charging requirements or user preference.

The shared secondary filtration component 6 handles power conditioning for both high frequency AC and DC operational modes, ensuring that regardless of whether the input originates from a plug-in DC charger or a wireless car pad (as high-frequency AC or as “pre-rectified” DC), the electrical characteristics of the charging module remain within acceptable parameters for safe and efficient operation.

Downstream, the secondary interface switch 9 is connected to a DC-DC converter 8, which transforms the voltage of the DC supplied to it from the secondary interface switch 9 to the voltage suitable for use by the electric vehicle's battery management system (BMS). The BMS then uses this DC to charge the battery of the electric vehicle.

The electrical circuitry of the OBC described above is described in terms of charging of the electric vehicle's battery. However, this charging module is bidirectional and can thus be used in an electric vehicle for discharging the battery's power to the grid or another load when required. Accordingly, it will be appreciated that all of the connections between the electrical components of the charging module described above are bidirectional (hence the use of double-headed arrows to indicate these connections in FIGS. 1 and 2).

Importantly, the PFC unit 5 has an inverter functionality, in addition to its rectifier functionality. This enables the PFC unit 5 to be bidirectional and thus convert an input DC to an output AC at high frequency at the appropriate frequency.

It will be appreciated that in such a bidirectional charging module the interfaces 1 and 2 may each be used as an input and/or as an output depending on the direction of current flow at any given time. Similarly, the DC output from the DC-DC converter 8 to the BMS during charging of the battery may instead be a DC input from the BMS to the DC-DC converter 8 when current flows in the other direction for supply to the grid or another load (i.e. during discharging).

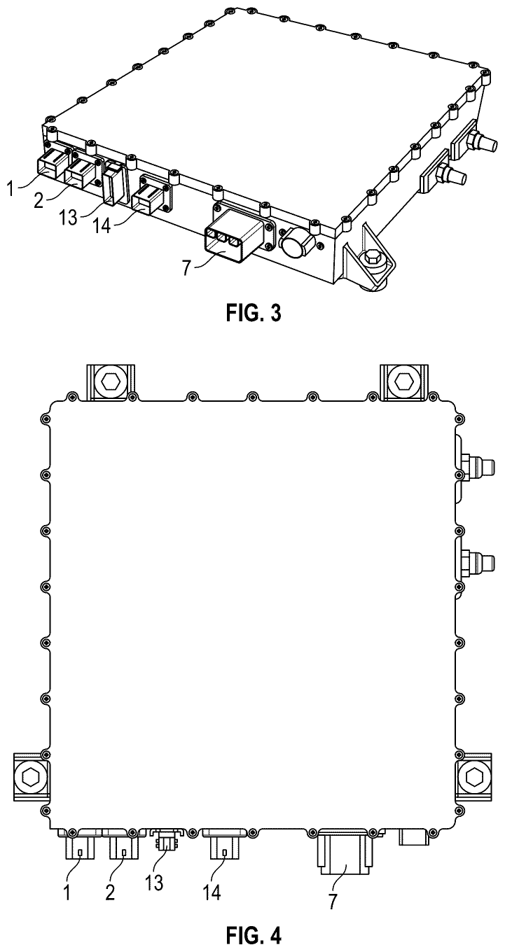

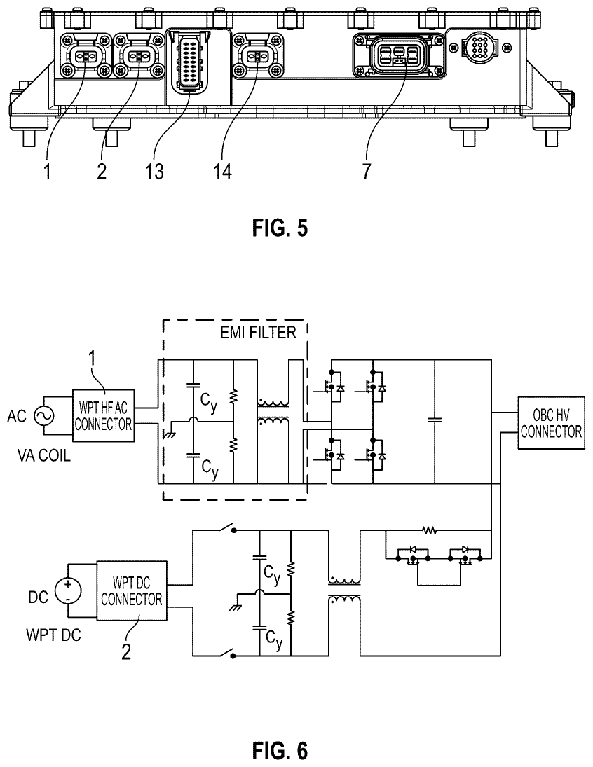

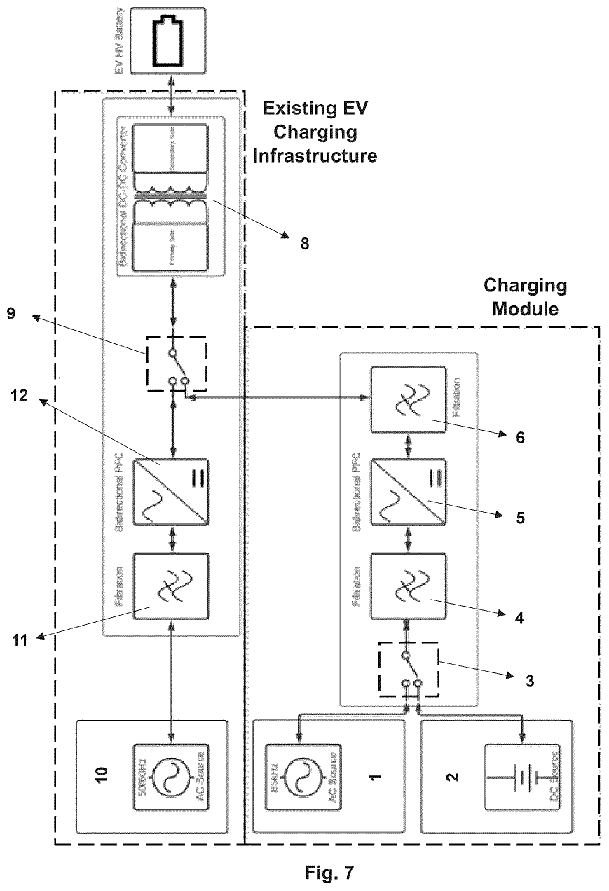

Once fitted or retrofitted to an EV, the charging module connects directly to the EV's existing charging system 7 via a connection port (as shown in FIGS. 3-5), allowing power to selectively routed using the secondary interface switch 9. This switch allows the vehicle to switch between the most appropriate power pathway depending on charging requirements, charging source availability, or user preference at the time. The secondary interface switch 9 manages power routing between the vehicle's existing charging system 7 and the present invention's charging module

The EV's existing charging system 7 provides all the necessary components to process the originally intended power input type for the vehicle (typically AC at frequencies of 50-60 Hz) as shown by the components included within the “existing charging system” section of FIG. 2. Therefore, input from the EV's existing charging system 7 is already rectified and filtered by the components present in the EV's existing charging system, by the time it reaches the charging module.

When a low frequency AC source (such as a conventional AC plug-in charger) is detected, the switch 9 can isolate the charging module and instead route power through the original vehicle's charging system. Power is received by the charging module from the EV's existing charging system 7 in the form of low frequency AC that has been rectified and filtered (DC). Importantly, the charging module of the invention does not provide components to process the power received from the EV's existing charging system 7, to avoid unnecessary component duplication.

Conversely, when a high-frequency AC source (such as a WPT car pad) is detected, the switch 9 isolates the vehicle's original charging system and routes power through the charging module of the invention. A similar situation occurs when a plug-in DC source (such as a dedicated DC plug-in charger) is used. In both cases, the interface switch 9 routes power through the charging module of the invention, enabling the EV to accept power types that the EV's existing charging system may not natively support.

In this example, the EV's existing charging system 7 enables bidirectional power flow with respect to AC at frequencies of 50 to 60 Hz. Hence, in this example, an EV fitted with the charging module of the invention is bidirectional with respect to AC at frequencies of 50 to 60 Hz as well as high frequency AC (at frequencies of 85 kHz) and DC.

However, as will be appreciated, not all existing EV's have bidirectional charging functionality, therefore in different examples of the invention bidirectionality with respect to AC at frequencies of 50 to 60 Hz (low frequency AC) may instead be achieved indirectly. For example, by utilising the bidirectional high-frequency AC interface 1 of the charging module, in combination with an alternating current (AC) frequency converter connected externally to the charging module. This external alternating current (AC) frequency converter would down-convert the high-frequency AC output from the charging module to the standard low-frequency AC required for grid or home power supply, thereby enabling full bidirectionality.

An alternative example of the internal circuitry and overall functionality provided by a charging module of the invention when retrofitted to an EV's existing charging system is also shown in FIG. 2. This figure illustrates the ability of the EV retrofitted with the charging module of the invention to be charged using low frequency AC by an AC plug-in charger via the EV's existing charging system. Alternatively, the EV may also be charged using high frequency AC or “pre-rectified” DC from a wireless car pad charger A or using DC from a dedicated plugin DC charger B via the charging module of the invention.

The typical charging system(s) possessed by known EV's is shown in FIG. 2. Typically, existing EV charging systems comprise a low frequency AC interface 10 configured to receive and output low frequency AC to and from an AC plug-in charger. The interface 10 is arranged upstream from a filtration component 11 which eliminates (or at least dampens) errant harmonics in the input low frequency AC. Connected directly downstream from the filtration component is typically a PFC unit 12. This PFC unit 12 has a rectifier functionality, and thus rectifies the input low frequency AC to DC before being passed into the charging module of the present invention.

FIG. 3 shows an overall perspective view of a charging module of the invention in aluminium housing, showing the positioning of the various connection ports (interfaces) on the charging module. Specifically, the connection ports facilitate the connection of the charging module to the high frequency AC and DC inputs/outputs, the EV's existing charging system, an external sensor interface and the EV's battery.

Connection port 1 serves as the high frequency interface AC 1 shown in FIGS. 1 and 2, this connection port allows a high frequency AC input/output to be directly connected to the charging module of the present invention. Connection port 2 serves as the DC interface 2 shown in FIGS. 1 and 2, this connection port allows the charging module of the present invention to receive/output DC via the car pad and/or a dedicated plug-in charger. Connection port 13 enables connection of the charging module to an external sensor interface that displays the temperature of the charging module. Connection port 14 facilitates connection of the charging module to the EV's battery (via the BMS). Finally, connection port 7 enables the EV's pre-existing charging system to be electrically connected to the charging module of the present invention.

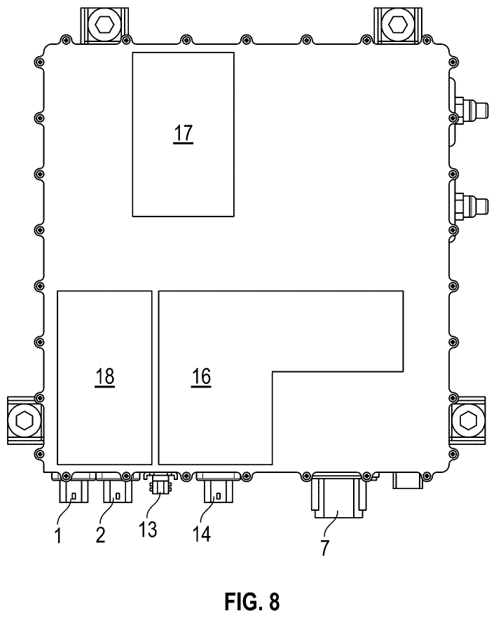

FIG. 8 shows a top-down view of a charging module of the invention, illustrating the positioning of key internal components described above. Specifically, the components 16, 17, 18 shown schematically on the charging module are necessary for the charging module to receive and deliver high frequency AC and DC as well as integrate with an EV's existing OBC. The power board 16 houses the PFC unit 5 as well as the primary and secondary filtration units 4, 6 which are shared across both the high frequency AC and DC input and output streams in this embodiment. The power board connects and integrates directly with the PFC unit 12 associated with the EV's existing OBC via a transformer 17. The control board 18 houses an internal controller which interfaces with the internal CAN network of the OBC in which it is being integrated and facilitates communication between the charging module and a controller associated with the EV's existing onboard charger.

### EXAMPLE 2—SWITCHING OF THE CHARGING MODULE OF EXAMPLE 1 BETWEEN MODES

It will be appreciated from Example 1 above that, at any given time, only one of the high frequency AC interface 1, or the DC interface 2 may be electrically connected to the charging module's output (“output” here meaning the DC output from the DC-DC converter 8 to the BMS during charging) and thus the BMS due to the presence of the switches 3, 9. Thus, by appropriately controlling the onwards connectivity of these two switches, one may control:
a) which of the AC interface and DC interface in the charging module are selected for connection to the battery at a particular time, and
b) whether the charging module itself or the EV's existing OBC are selected for connection to the battery at a particular time.

It will be appreciated that, in FIG. 1, the DC interface 2 is currently selected and thus the OBC shown is in the DC mode.

The charging module of Example 1 has a high frequency AC mode whereby the high frequency AC interface 1 is selected. The charging module also has a DC mode whereby the DC interface 2 is selected (as in FIG. 1). When retrofitted to an EV, the charging module also allows for switching between the EV's existing charging system 7 and the charging module itself. This enables the EV's battery to be charged using power types accepted by the pre-existing OBC in the vehicle or by the additional power types accepted by the charging module.

The selection of the high frequency AC or DC mode is achieved by appropriately positioning a interface switch 3 and primary selection between the EV's existing charging system 7 and the charging module is achieved by appropriately positioning secondary interface switch 9.

Once fitted or retrofitted to an EV, the charging module establishes a direct connection to an EV's existing charging system 7 via the secondary interface switch 9. This secondary interface switch 9 enables switching between the charging functionality provided by the EV's existing charging system and the charging functionality provided by the charging module of the invention.

When the electric vehicle is charging wirelessly, and power is thus received by a car pad of the electric vehicle, the high frequency AC mode or the DC mode may be selected.

Specifically, in the high frequency AC mode, power is received as high frequency AC via the high frequency AC interface. In the DC mode, power is received as DC via the DC interface either from a dedicated plug-in DC charger or from the car pad of the electric vehicle. The selection of the high frequency AC mode or the DC mode may depend on whether the charging module has been installed as part of a new electric vehicle or retrofitted as part of an older electric vehicle having a rectifier component separate to the OBC.

The charging module enables older electric vehicles to be retrofitted with additional charging functionality and accept power from a car pad of the electric vehicle via a high frequency AC in a high frequency AC mode or “pre-rectified” DC input in a DC mode.

The specific mode selected will depend on the specific application of the charging module (including the specific vehicle to which it is retrofit) and the choice of the electric vehicle's user, operator, or manufacturer.

The switches 3, 9 may be controlled by a variety of means, including by manual inputs from the user/operator of the electric vehicle, as well as by the control system of the invention (such as a charging module controller). Again, the control means used to switch the charging module between the three modes as applicable will be for the user, operator, or manufacturer of the electric vehicle to decide, as appropriate.

What is claimed is:

1. A charging module for an electric vehicle (EV), the charging module comprising:
a high frequency AC interface, configured to receive and externally output AC at a high frequency of 70 kHz-95 kHz in a high frequency AC mode,
a DC interface, configured to receive and externally output DC in a DC mode,
a rectification component,
a first switch configured to switch the charging module between the high frequency AC mode and the DC mode, and
optionally, a second switch configured to switch between the existing EV onboard charger and the charging module,
wherein the charging module is configured to be coupled to an existing EV onboard charger, to enable the onboard charger to receive and externally output high frequency AC and DC.

2. A charging module according to claim 1, further comprising one or more filtration components, wherein at least one of the one or more filtration components are used in both the high frequency AC mode and DC mode and configured to filter high-order harmonics present in high frequency AC input or DC input received from a car pad of the electric vehicle.

3. A charging module according to claim 2, wherein the one or more filtration components comprise a primary filtration component that is used in both the high-frequency AC mode and the DC mode, the primary filtration component being configured to filter high-order harmonics present in a high-frequency AC input or DC input received from a car pad of the electric vehicle, and is electrically connected between the first switch and the second switch.

4. A charging module according to claim 2, wherein the one or more filtration components further comprise a secondary filtration component being configured to reduce errant harmonics and is electrically connected between the first switch and the high frequency AC interface.

5. A charging module according to claim 3, wherein the primary filtration component comprises a RC or LCL filtration circuit capable of filtering residual errant frequencies and high-order harmonics present in a high-frequency AC input or DC input received from a car pad of the electric vehicle.

6. A charging module according to claim 3, wherein the rectification component is electrically connected downstream from the primary filtration component.

7. A charging module according to claim 4, wherein the primary filtration component, secondary filtration component and rectification component are used in both the high-frequency AC mode and the DC mode.

8. A charging module according to claim 1, wherein the high frequence AC interface is configured to receive and output high frequency AC wirelessly via a car pad of the electric vehicle.

9. A charging module according to claim 1, wherein the DC interface is configured to receive and output direct current via a plug-in connection from a plug-in DC charger.

10. A charging module according to claim 1, wherein the DC interface is additionally configured to receive direct current from a car pad of the electric vehicle.

11. A charging module as claimed in claim 1, wherein the charging module is configured to communicate with the existing EV onboard charger via a local CAN network associated with the existing EV onboard charger.

12. A charging module as claimed in claim 1, wherein the charging module comprises a control network for controlling one or more interfaces of the charging module.

13. A charging module as claimed in claim 12, wherein the control network comprises one or more sub-networks.

14. A charging module as claimed in claim 13, wherein the control network comprises a sub-network for controlling the high frequency AC interface and for controlling the DC interface.

15. An EV comprising a charging module as claimed in claim 1, wherein the EV is configured to receive and externally output into and out of a battery of the EV;
a) an AC at a high frequency of 70 kHz-95 kHz, through a high frequency AC interface in a high frequency AC mode,
b) a DC through a DC interface in a DC mode.

16. A method of fitting a charging module as claimed in claim 1 to an electric vehicle, comprising electrically connecting the charging module to an existing EV Onboard Charger, to enable the existing EV Onboard Charger to additionally receive and externally output:
a) an alternating current at a high frequency of 70 kHz-95 kHz, and
(b) a direct current.

17. A kit for fitting to an EV, which upon fitting configures a pre-existing onboard charger on the EV to additionally receive and externally output:
a) an alternating current at a high frequency of 70 kHz-95 kHz, through a high frequency AC interface in a high frequency AC mode, and
(b) a direct current through a DC interface in a DC mode, wherein the kit comprises a rectification component, a first switch configured to switch the kit between the high frequency AC mode and the DC mode, and a second switch configured to switch between the pre-existing EV onboard charger and the charging module.
